(19) United States
(12) Patent Application Publication
(10) Pub. No.: US 2025/0149242 A1
(43) Pub. Date: May 8, 2025

(54) MULTILAYER CERAMIC CAPACITOR

(71) Applicant: SAMSUNG ELECTRO-MECHANICS CO., LTD., Suwon-si (KR)

(72) Inventors: Yunsung Kang, Suwon-si (KR); Sun-Hwa Kim, Suwon-si (KR); Wonjun Na, Suwon-si (KR); Hyunsoo Park, Suwon-si (KR); Byeonggyu Park, Suwon-si (KR); Myeonghan Yu, Suwon-si (KR); Sungjoon Park, Suwon-si (KR)

(73) Assignee: SAMSUNG ELECTRO-MECHANICS CO., LTD., Suwon-si (KR)

(21) Appl. No.: 18/439,154

(22) Filed: Feb. 12, 2024

(30) Foreign Application Priority Data
Nov. 2, 2023 (KR) 10-2023-0149958

(51) Int. Cl. H01G 4/008; H01G 4/12; H01G 4/30

(52) U.S. Cl. CPC H01G 4/008; H01G 4/1209; H01G 4/306

(57) ABSTRACT

A multilayer ceramic capacitor may include a ceramic body including a first surface and a second surface facing each other in a first direction, a third surface and a fourth surface facing each other in a second direction and connecting the first surface and the second surface, a fifth surface and a sixth surface facing each other in a third direction and connecting the first surface and the second surface, a plurality of first internal electrodes and a plurality of second internal electrodes disposed inside the ceramic body, and a first external electrode disposed outside the ceramic body, where the first external electrode may include a first metal layer disposed on the first surface and the sixth surface of the ceramic body and electrically connected to the plurality of first internal electrodes on the first surface, and a first plated layer disposed on the first metal layer.

### CROSS-REFERENCE TO RELATED APPLICATION

This application claims priority to and the benefit of Korean Patent Application No. 10-2023-0149958 filed in the Korean Intellectual Property Office on Nov. 2, 2023, the entire contents of which is incorporated herein by reference.

### BACKGROUND

### Technical Field

The present disclosure relates to a multilayer ceramic capacitor.

### Description of the Related Art

Electronic components using ceramic materials include capacitors, inductors, piezoelectric elements, varistors, or thermistors. Among these ceramic electronic components, a multilayer ceramic capacitors (MLCC) may be used in various electronic devices due to their small size, high capacitance, and ease of mounting.

For example, multilayer ceramic capacitor may be used in a condenser in the form of a chip that is mounted on a substrate of various electronic products, such as an imaging device such as liquid crystal display (LCD), plasma display panel, an organic light-emitting diode (OLED), a computer, a personal portable terminal and a smart phone, to charge and discharge electricity.

The multilayer ceramic capacitor may include internal electrodes disposed inside the ceramic body and external electrodes disposed outside the ceramic body and connected to the internal electrodes. The external electrode may be formed by dipping and blotting the ceramic body in the external electrode forming paste. In this case, the thickness of the external electrode is tens of μm, which is relatively thick, and there is a problem in that it is difficult to reduce the volume occupied by the external electrode.

### SUMMARY

The present disclosure attempts to provide a multilayer ceramic capacitor that includes external electrodes with reduced volume.

However, the object of the present disclosure is not limited to the aforementioned one, and may be extended in various ways within the spirit and scope of the present disclosure.

A multilayer ceramic capacitor may include a ceramic body including a first surface and a second surface facing each other in a first direction, a third surface and a fourth surface facing each other in a second direction and connecting the first surface and the second surface, a fifth surface and a sixth surface facing each other in a third direction and connecting the first surface and the second surface, a plurality of first internal electrodes and a plurality of second internal electrodes disposed inside the ceramic body, a first external electrode disposed outside the ceramic body, and a second external electrode disposed outside the ceramic body, where the first external electrode may include (i) a first metal layer disposed on the first surface and the sixth surface of the ceramic body and electrically connected to the plurality of first internal electrodes on the first surface, and (ii) a first plated layer disposed on the first metal layer, and where the second external electrode may include (i) a second metal layer disposed on the second surface and the sixth surface of the ceramic body and electrically connected to the plurality of second internal electrodes on the second surface, and (ii) a second plated layer disposed on the second metal layer.

The multilayer ceramic capacitor may further include an insulation layer that covers a portion of the first external electrode on the sixth surface of the ceramic body and a portion of the second external electrode on the sixth surface of the ceramic body.

The insulation layer may expose a portion of an outer surface of the first external electrode opposing the sixth surface of the ceramic body and cover a remaining portion of the first external electrode, and may expose a portion of an outer surface of the second external electrode opposing the sixth surface of the ceramic body and cover a remaining portion of the second external electrode.

The outer surface of the first external electrode that is exposed by the insulation layer may have a rectangular shape including four edges surrounded by the insulation layer, as viewed in a cross-section of the multilayer ceramic capacitor.

The outer surface of the second external electrode that is exposed by the insulation layer may have a rectangular shape including four edges surrounded by the insulation layer, as viewed in a cross-section of the multilayer ceramic capacitor.

The insulation layer may cover the sixth surface of the ceramic body between the first external electrode and the second external electrode.

The insulation layer may cover the first external electrode on the first surface of the ceramic body, and may coves the second external electrode on the second surface of the ceramic body.

The first plated layer may include a first layer that covers the first metal layer, a second layer that covers the first layer, and a third layer that covers the second layer.

The first layer may include nickel (Ni), the second layer may include copper (Cu), and the third layer may include tin (Sn).

The second plated layer may include a first layer that covers the second metal layer, a second layer that covers the first layer, and a third layer that covers the second layer.

The first layer may include nickel (Ni), the second layer may include copper (Cu), and the third layer may include tin (Sn).

Each of the first metal layer and the second metal layer may include a nickel (Ni) layer, a layer including titanium (Ti), and a layer including copper (Cu), or a layer including titanium (Ti), and a layer including chromium (Cr).

Each of the first plated layer and the second plated layer may include a layer including nickel (Ni), and a layer including tin (Sn), a first layer including tin (Sn), a layer including nickel (Ni), and a second layer including tin (Sn), or a layer including nickel (Ni), a layer including copper (Cu), and a layer including tin (Sn).

A thickness of the first internal electrode may be 100 nm or more and 300 nm or less, and a thickness of the second internal electrode may be 100 nm or more and 300 nm or less.

The first metal layer may be disposed only on the first surface and the sixth surface of the ceramic body.

The multilayer ceramic capacitor may further include an insulation layer that covers a portion of the first external electrode on the sixth surface of the ceramic body and a portion of the second external electrode on the sixth surface of the ceramic body.

The insulation layer may expose a portion of an outer surface of the first external electrode opposing the sixth surface of the ceramic body and may cover a remaining portion of the first external electrode, and may expose a portion of an outer surface of the second external electrode opposing the sixth surface of the ceramic body and may cover a remaining portion of the second external electrode.

The first plated layer may be disposed only on the first surface and the sixth surface of the ceramic body.

According to a multilayer ceramic capacitor according to an embodiment, the portion contributing to capacitance may be enlarged by reducing the volume of the external electrode.

### BRIEF DESCRIPTION OF THE DRAWINGS

FIG. 1 is a perspective view schematically illustrating a multilayer ceramic capacitor according to an embodiment.

FIG. 2 is a cross-sectional view taken along line II-II′ of FIG. 1.

FIG. 3 is an exploded perspective view showing the stacking of internal electrodes in the multilayer ceramic capacitor of FIG. 1.

FIG. 4 is a perspective view schematically illustrating a multilayer ceramic capacitor according to another embodiment.

FIG. 5 is a cross-sectional view taken along line V-V′ of FIG. 4.

### DETAILED DESCRIPTION

The present disclosure will be described more fully hereinafter with reference to the accompanying drawings, in which embodiments of the disclosure are shown. The drawings and description are to be regarded as illustrative in nature and not restrictive. Like reference numerals designate like elements throughout the specification. In addition, some constituent elements are exaggerated, omitted, or briefly illustrated in the added drawings, and sizes of the respective constituent elements do not reflect the actual sizes.

The accompanying drawings are provided only in order to allow embodiments disclosed in the present specification to be easily understood and are not to be interpreted as limiting the spirit disclosed in the present specification, and it is to be understood that the present disclosure includes all modifications, equivalents, and substitutions without departing from the scope and spirit of the present disclosure.

Terms including ordinal numbers such as “first”, “second”, and the like will be used only to describe various constituent elements, and are not to be interpreted as limiting these constituent elements. The terms are only used to differentiate one constituent element from other constituent elements.

It will be understood that when an element such as a layer, film, region, area, or substrate is referred to as being “on” or “above” another element, it can be directly on the other element or intervening elements may also be present. In contrast, when an element is referred to as being “directly on” another element, there are no intervening elements present. Further, in the specification, the word “on” or “above” means disposed on or below the object portion, and does not necessarily mean disposed on the upper side of the object portion based on a gravitational direction.

Throughout the specification, it should be understood that the term “include”, “comprise”, “have”, or “configure” indicates that a feature, a number, a step, an operation, a constituent element, a part, or a combination thereof described in the specification is present, but does not exclude a possibility of presence or addition of one or more other features, numbers, steps, operations, constituent elements, parts, or combinations, in advance. Unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Furthermore, throughout the specification, “connected” does not only mean when two or more elements are directly connected, but also when two or more elements are indirectly connected through other elements, and when they are physically connected or electrically connected, and further, it may be referred to by different names depending on a position or function, and may also be referred to as a case in which respective parts that are substantially integrated are linked to each other.

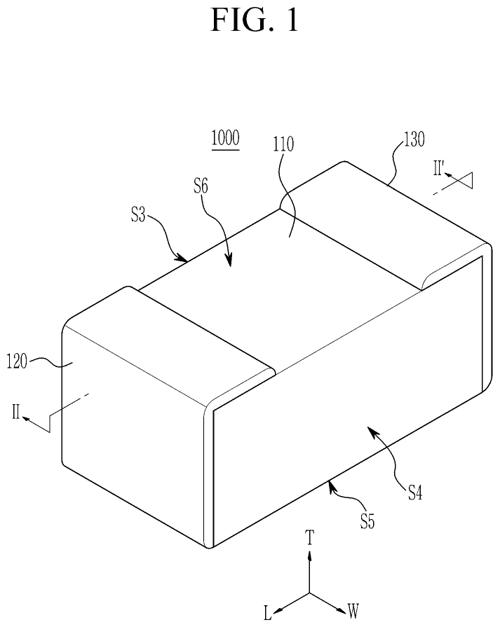

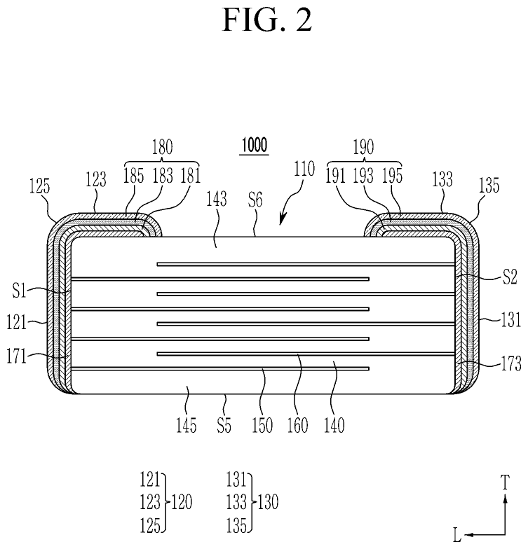

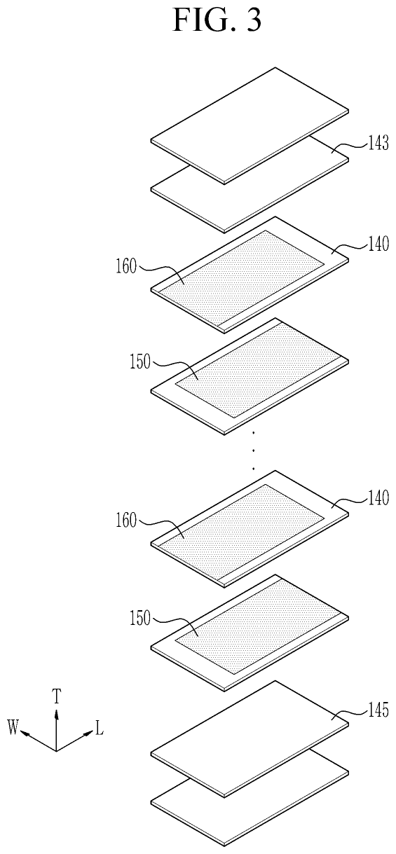

FIG. 1 is a perspective view schematically illustrating a multilayer ceramic capacitor according to an embodiment. FIG. 2 is a cross-sectional view taken along line II-II′ of FIG. 1. FIG. 3 is an exploded perspective view showing the stacking of internal electrodes in the multilayer ceramic capacitor of FIG. 1.

Referring to FIG. 1, FIG. 2 and FIG. 3, a multilayer ceramic capacitor 1000 according to the present embodiment includes a ceramic body 110, a first external electrode 120, a second external electrode 130, a plurality of first internal electrodes 150 and a plurality of second internal electrodes 160.

First, defining directions to clearly describe the present embodiment, the L-axis, the W-axis, and the T-axis shown in the drawings refer to axes representing a length direction, a width direction, and a thickness direction of the multilayer ceramic capacitor 1000, respectively.

The thickness direction (T-axis direction) may be a direction perpendicular to a wide surface (major surface) of sheet-like constituent elements. For example, the thickness direction (T-axis direction) may be used as the same concept as the direction in which dielectric layers 140 are stacked.

The length direction (L-axis direction) is a direction parallel to the wide surfaces (main surfaces) of the sheet-like components, and may be a direction that intersects (or is orthogonal to) the thickness direction (T-axis direction). For example, the length direction (L-axis direction) may be a direction in which the first external electrode 120 and the second external electrode 130 face each other.

The width direction (W-axis direction) is a direction parallel to the wide surface (main surface) of the sheet-like components, and may be a direction that simultaneously intersects (or crosses) the thickness direction (T-axis direction) and the length direction (L-axis direction).

The ceramic body 110 may have a substantially hexahedral shape, but the present embodiment is not limited thereto. Due to contraction during sintering, the ceramic body 110 may have a substantially hexahedral shape, although not a perfect hexahedral shape. For example, the ceramic body 110 has a substantially rectangular hexahedral shape, but corner or vertex portions may have a rounded shape.

In the present embodiment, for convenience of description, surfaces facing each other in the length direction (L-axis direction) are defined as a first surface S1 and a second surface S2, surfaces facing each other in the width direction (W-axis direction) and connecting the first surface S1 and the second surface S2 are defined as a third surface S3 and a fourth surface S4, and surfaces facing each other in the thickness direction (T-axis direction) and connecting the first surface S1 and the second surface S2 are defined as a fifth surface S5 and a sixth surface S6.

Therefore, a first direction, which is a direction in which the first surface S1 and the second surface S2 face each other, may be the length direction (L-axis direction), and a second direction and a third direction that are perpendicular to the first direction and perpendicular to each other may be the thickness direction (T-axis direction) and the width direction (W-axis direction), respectively, or the width direction (W-axis direction) and the thickness direction (T-axis direction), respectively.

A length of the ceramic body 110 may mean, based on an optical microscope or scanning electron microscope (SEM) photograph of a cross-section taken in the length direction (L-axis direction)-the thickness direction (T-axis direction) at a center of the ceramic body 110 in the width direction (W-axis direction), a maximum value of lengths of a plurality of line segments that connect two outermost boundary lines facing each other in the length direction (L-axis direction) of the ceramic body 110 shown in the above cross-sectional photograph and are parallel to the length direction (L-axis direction). Meanwhile, the length of the ceramic body 110 may mean a minimum value of lengths of a plurality of line segments that connect two outermost boundary lines facing each other in the length direction (L-axis direction) of the ceramic body 110 shown in the above-mentioned cross-section photograph and are parallel to the length direction (L-axis direction), respectively. Alternatively, the length of the ceramic body 110 may mean an arithmetic mean value of lengths of at least two of a plurality of line segments that connect two outermost boundary lines facing each other in the length direction (L-axis direction) of the ceramic body 110 shown in the above cross-sectional photograph and are parallel to the length direction (L-axis direction).

A thickness of the ceramic body 110 may mean, based on an optical microscope or scanning electron microscope (SEM) photograph of a cross-section taken in the length direction (L-axis direction)—the thickness direction (T-axis direction) at a center of the ceramic body 110 in the width direction (W-axis direction), a maximum value of lengths of a plurality of line segments that connect two outermost boundary lines facing each other in the thickness direction (T-axis direction) of the ceramic body 110 shown in the above cross-sectional photograph and are parallel to the thickness direction (T-axis direction). Meanwhile, the thickness of the ceramic body 110 may mean a minimum value of lengths of a plurality of line segments that connect two outermost boundary lines facing each other in the thickness direction (T-axis direction) of the ceramic body 110 shown in the above-mentioned cross-sectional photograph and are parallel to the thickness direction (T-axis direction), respectively. Meanwhile, the thickness of the ceramic body 110 may mean an arithmetic mean value of lengths of at least two line segments among a plurality of line segments that connect two outermost boundary lines facing each other in the thickness direction (T-axis direction) of the ceramic body 110 shown in the above-mentioned cross-sectional photograph and parallel to the thickness direction (T-axis direction), respectively.

A width of the ceramic body 110 may mean, based on an optical microscope or scanning electron microscope (SEM) photograph of a cross-section taken in the length direction (L-axis direction)-the width direction (W-axis direction) at a center of the ceramic body 110 in the thickness direction (T-axis direction), a maximum value of lengths of a plurality of line segments that connect two outermost boundary lines facing each other in the width direction (W-axis direction) of the ceramic body 110 shown in the above cross-sectional photograph and are parallel to the width direction (W-axis direction). Meanwhile, the width of the ceramic body 110 may mean a minimum value of lengths a plurality of line segments that connect two outermost boundary lines facing each other in the width direction (W-axis direction) of the ceramic body 110 shown in the above-mentioned cross-section photograph and are parallel to the width direction (W-axis direction), respectively. On the other hand, the width of the ceramic body 110 may mean an arithmetic mean value of lengths of at least two line segments among a plurality of line segments that connect two outermost boundary lines facing each other in the width direction (W-axis direction) of the ceramic body 110 shown in the above-mentioned cross-section photograph and are parallel to the width direction (W-axis direction), respectively.

The ceramic body 110 may include a plurality of dielectric layers 140 stacked in the thickness direction (T-axis direction). A boundary between the dielectric layers 140 may be unclear. For example, the boundary between the dielectric layers 140 may be difficult to confirm without using a scanning electron microscope (SEM), and the plurality of dielectric layers 140 may appear to be an integral structure.

The first internal electrode 150 and the second internal electrode 160 may be alternately stacked interposing the dielectric layer 140 therebetween. This stacked structure may be repeated within the ceramic body 110, the internal electrode closest to the fifth surface S5 of the ceramic body 110 may be the first internal electrode 150 or the second internal electrode 160 and the internal electrode closest to the sixth surface S6 may be the first internal electrode 150 or the second internal electrode 160.

The first internal electrode 150 and the second internal electrode 160 have different polarities, and may be electrically insulated from each other by the dielectric layer 140 disposed therebetween.

The first internal electrode 150 and the second internal electrode 160 may be disposed to be offset from each other in the length direction (L-axis direction) interposing the dielectric layer 140 therebetween. An end portion of the first internal electrode 150 may be exposed from the first surface S1 of the ceramic body 110, and an end portion of the second internal electrode 160 may be exposed from the second surface S2 of the ceramic body 110. The end portion of the first internal electrode 150 exposed from the first surface S1 of the ceramic body 110 may be connected to the first external electrode 120. The end portion of the second internal electrode 160 exposed from the second surface S2 of the ceramic body 110 may be connected to the second external electrode 130.

The first internal electrode 150 and the second internal electrode 160 may be formed by using a thin film deposition method such as sputtering, vacuum deposition, and chemical vapor deposition (CVD). By using a thin film deposition method, a thin and uniform internal electrode may be formed.

If the size of the ceramic body is constant, the thinner the thickness of the internal electrode, the more dielectric layers can be stacked, thereby increasing the capacity of the multilayer ceramic capacitor. Additionally, the reduced thickness of the internal electrode may allow an increase in the thickness of the dielectric layer, so the breakdown voltage and high temperature reliability may be improved by increasing the thickness of the dielectric layer.

For example, the thickness of the first internal electrode 150 and the second internal electrode 160 formed by the thin film deposition method may be 100 nm or more and 300 nm or less, respectively. If the thickness of the internal electrode is less than 100 nm, the resistance increases as the thickness decreases, which may increase the equivalent serial resistance (ESR), and if it exceeds 300 nm, there is a relative limit to the increase in the thickness of the dielectric layer, so the effectiveness of increasing reliability may be reduced.

Here, the thickness of the internal electrode may mean an average thickness of one internal electrode disposed between two dielectric layers. Based on scanning electron microscope (SEM) photograph at a magnification of 10,000 of a cross section taken in the length direction (L-axis direction)-the thickness direction (T-axis direction) at the central portion of the ceramic body 110 in the width direction (W-axis direction), the average thickness of the internal electrode may be an arithmetic mean of the thickness of one internal electrode shown in the above-mentioned cross-sectional photograph, measured at 30 evenly spaced points in the length direction (L-axis direction). The above-mentioned 30 points may be designated in an active region described later. By measuring the average thickness of each of the 10 internal electrodes in this way and then deriving the arithmetic mean of the measured values, the average thickness of the internal electrodes may be further generalized. Other methods and/or tools appreciated by one of ordinary skill in the art, even if not described in the present disclosure, may also be used.

Meanwhile, an internal electrode may be formed by printing a conductive paste that contains a conductive metal on the surface of the dielectric layer 140. For example, internal electrodes may be formed by printing a conductive paste that contains nickel (Ni) or a nickel (Ni) alloy on the surface of the dielectric layer by screen printing or gravure printing. However, in this case, unlike the case of forming the internal electrode using the thin film deposition method described above, there is a problem in that it is difficult to form an internal electrode with a thin and uniform thickness.

When a voltage is applied to the first external electrode 120 and the second external electrode 130, charges are accumulated between the first internal electrode 150 and the second internal electrode 160 that face each other. That is, a capacitance may be obtained between the first internal electrode 150 electrically connected to the first external electrode 120 and the second internal electrode 160 electrically connected to the second external electrode 130. A capacitance of the multilayer ceramic capacitor 1000 is proportional to an overlapping area of the first internal electrode 150 and the second internal electrode 160 that overlap each other along the thickness direction (T-axis direction).

In other words, the multilayer ceramic capacitor 1000 may include an active region and a margin region. The active region may refer to a region where the first internal electrode 150 and the second internal electrode 160 overlap along the thickness direction (T-axis direction), and the margin region may refer to a region between the first surface S1 of the ceramic body 110 and the active region and a region between the second surface S2 of the ceramic body 110 and the active region.

The multilayer ceramic capacitor 1000 is categorized based on its length and width. Therefore, even in multilayer ceramic capacitors having the same length or width, the size of the ceramic body may vary according to the thickness of the external electrode. That is, a multilayer ceramic capacitor having a thinner external electrode may have a larger ceramic body than a multilayer ceramic capacitor having a thicker external electrode. A larger ceramic body may mean a larger active region, which in turn may mean a larger capacitance. As a result, capacitance may increase as the external electrode of the multilayer ceramic capacitor becomes thinner. In the present embodiment, by using a metal layer as a seed layer for plating growth when forming the external electrode of the multilayer ceramic capacitor, the thickness of the external electrode may be reduced and advantageous effects according thereto may be obtained. This will be explained in more detail below.

A first cover layer 143 and a second cover layer 145 may be disposed outside of the active region in the thickness direction (T-axis direction).

The first cover layer 143 is disposed between the sixth surface S6 of the ceramic body 110 and the internal electrode closest thereto. The second cover layer 145 is disposed between the fifth surface S5 of the ceramic body 110 and the internal electrode closest thereto.

That is, in the ceramic body 110, the first cover layer 143 may be disposed above the uppermost internal electrode, and the second cover layer 145 may be disposed below the lowermost internal electrode. The first cover layer 143 and the second cover layer 145 may have the same composition as the dielectric layer 140. The first cover layer 143 and the second cover layer 145 may be formed by stacking one or more dielectric layers on each of an outer surface of the uppermost internal electrode and an outer surface of the lowermost internal electrode.

The first cover layer 143 and the second cover layer 145 may serve to prevent damage to the first internal electrode 150 and the second internal electrode 160 due to physical or chemical stress.

The dielectric layer 140 may include a ceramic material having a high permittivity. For example, the ceramic material may include dielectric material ceramic that contains components such as BaTiO₃, CaTiO₃, SrTiO₃, or CaZrO₃, and the like. In addition, an auxiliary component, such as a manganese (Mn) compound, an iron (Fe) compound, a chromium (Cr) compound, a cobalt (Co) compound, and a nickel (Ni) compound may be further added to these components. For example, the dielectric layer may include (Ba₁₋ₓCaₓ)TiO₃, Ba(Ti_{1-y}Ca_{y})O₃, (Ba₁₋ₓCaₓ)(Ti_{1-y}Zr_{y})O₃ or Ba(Ti_{1-y}Zr_{y})O₃, and the like, in which calcium (Ca), zirconium (Zr), and the like are partially dissolved into BaTiO₃, however, the present disclosure is not limited thereto.

In addition, at least one of a ceramic additive, an organic solvent, a plasticizer, a binder, and a dispersant may be further included in the dielectric layer 140. The ceramic additive may be, for example, a transition metal oxide or transition metal carbide, a rare-earth element, magnesium (Mg), aluminum (Al), and the like.

For example, the average thickness of the dielectric layer 140 may be 0.1 μm to 10 μm, but the present embodiment is not limited thereto.

The first external electrode 120 and the second external electrode 130 are disposed at an exterior of the ceramic body 110.

The first external electrode 120 may be disposed on the first surface S1 and the sixth surface S6 of the ceramic body 110. The second external electrode 130 may be disposed on the second surface S2 and the sixth surface S6 of the ceramic body 110.

The first external electrode 120 includes a first end portion 121, a first band portion 123 and a first edge portion 125.

The first end portion 121 covers the first surface S1 of the ceramic body 110, and is a portion electrically connected to the exposed end portion of the plurality of first internal electrodes 150.

The first band portion 123 extends from the first end portion 121 and covers a portion of the sixth surface S6 of the ceramic body 110. The first band portion 123 may allow the first external electrode 120 to be more strongly adhered to the ceramic body 110.

The first edge portion 125 may be a portion connecting the first end portion 121 and the first band portion 123.

The second external electrode 130 includes a second end portion 131, a second band portion 133, and a second edge portion 135, respectively.

The second end portion 131 covers the second surface S2 of the ceramic body 110, and is a portion electrically connected to the exposed end portion of the plurality of second internal electrodes 160.

The second band portion 133 extends from the second end portion 131 and covers a portion of the sixth surface S6 of the ceramic body 110. The second band portion 133 may allow the second external electrode 130 to be more strongly adhered to the ceramic body 110.

The second edge portion 135 may be a portion connecting the second end portion 131 and the second band portion 133.

Based on an optical microscope or scanning electron microscope (SEM) image of a cross-section taken in the length direction (L-axis direction)-the thickness direction (T-axis direction) at a central portion of the multilayer ceramic capacitor 1000 in the width direction (W-axis direction), in the multilayer ceramic capacitor 1000 shown in the above-mentioned cross-sectional photograph, the first end portion 121 and the second end portion 131 may have a shape generally parallel to the thickness direction (T-axis direction), the first band portion 123 and the second band portion 133 may have a shape generally parallel to the length direction (L-axis direction), and the first edge portion 125 and the second edge portion 135 may have a curved shape. The above-described curved shape may be a curved shape having a tangent whose slope changes from a direction parallel to the thickness direction (T-axis direction) to a direction parallel to the length direction (L-axis direction) (or vice versa).

The first external electrode 120 may include a first metal layer 171 and a first plated layer 180, and the second external electrode 130 may include a second metal layer 173 and a second plated layer 190.

The first external electrode 120 may include the first metal layer 171 and the first plated layer 180 on the first metal layer 171.

The first metal layer 171 directly contacts the ceramic body 110. For example, the first metal layer 171 may cover at least a portion of the first surface S1 and the sixth surface S6 of the ceramic body 110.

The first metal layer 171 may include a conductive metal. The conductive metal may include nickel (Ni), copper (Cu), titanium (Ti), chromium (Cr), or the like, alone or an alloy thereof, but the present embodiment is not limited thereto. For example, the first metal layer 171 may include a nickel (Ni) layer, a layer including titanium (Ti), and a layer including copper (Cu), or a layer including titanium (Ti), and a layer including chromium (Cr).

The method of forming the first metal layer 171 is not particularly limited. For example, the first metal layer 171 may be formed into a thin film by sputtering, E-beam evaporation, atomic layer deposition (ALD), chemical vapor deposition (CVD), or the like.

The second external electrode 130 may include the second metal layer 173 and the second plated layer 190 on the second metal layer 173.

The second metal layer 173 directly contacts the ceramic body 110. The second metal layer 173 may cover at least a portion of the second surface S2 and the sixth surface S6 of the ceramic body 110.

The second metal layer 173 may include a conductive metal. The conductive metal may include nickel (Ni), copper (Cu), titanium (Ti), chromium (Cr), or the like, alone or an alloy thereof, but the present embodiment is not limited thereto. For example, the second metal layer 173 may include a nickel (Ni) layer, a layer including titanium (Ti), and a layer including copper (Cu), or a layer including titanium (Ti), and a layer including chromium (Cr).

The method of forming the second metal layer 173 is not particularly limited. For example, the second metal layer 173 may be formed into a thin film by sputtering, E-beam evaporation, atomic layer deposition (ALD), chemical vapor deposition (CVD), or the like.

The first plated layer 180 is disposed on the first metal layer 171, and the second plated layer 190 is disposed on the second metal layer 173. That is, the first plated layer 180 may cover the first metal layer 171, and the second plated layer 190 may cover the second metal layer 173.

The first plated layer 180 may be formed by directly plating a conductive metal on the first metal layer 171. That is, the first metal layer 171 may serve as a seed layer for plating. In addition, the second plated layer 190 may be formed by directly plating a conductive metal on the second metal layer 173. That is, the second metal layer 173 may serve as a seed layer for plating. Here, the conductive metal may include nickel (Ni), copper (Cu), tin (Sn), palladium (Pd), platinum (Pt), gold (Au), silver (Ag), tungsten (W), titanium (Ti), lead (Pb), or the like, alone or an alloy thereof, but the present embodiment is not limited thereto.

Both the first plated layer 180 and the second plated layer 190 may comprise a plurality of layers. For example, the first plated layer 180 may include a first layer 181 that covers the first metal layer 171, a second layer 183 that covers the first layer 181, and a third layer 185 that covers the second layer 183. The first layer 181 may include copper (Cu), the second layer 183 may include nickel (Ni), and the third layer 185 may include tin (Sn), but the present embodiment is not limited thereto.

In addition, the second plated layer 190 may include a first layer 191 that covers the second metal layer 173, a second layer 193 that covers the first layer 191, and a third layer 195 that covers the second layer 193. The first layer 191 may include copper (Cu), the second layer 193 may include nickel (Ni), and the third layer 195 may include tin (Sn), but the present embodiment is not limited thereto.

As another example, the first plated layer 180 may include a layer including nickel (Ni), and a layer including tin (Sn), a first layer including tin (Sn), a layer including nickel (Ni), and a second layer including tin (Sn), or a layer including nickel (Ni), a layer including copper (Cu), and a layer including tin (Sn), and the second plated layer 190 may include a layer including nickel (Ni), and a layer including tin (Sn), a first layer including tin (Sn), a layer including nickel (Ni), and a second layer including tin (Sn), or a layer including nickel (Ni), a layer including copper (Cu), and a layer including tin (Sn).

As in the present embodiment, when a plated layer is formed using a metal layer as a seed layer for plating growth, external electrodes may be formed with a small thickness. In this case, the volume occupied by the external electrode is relatively reduced, so the portion contributing to the capacitance may become relatively larger. Therefore, according to the present embodiment, the performance of the multilayer ceramic capacitor may be improved.

Unlike the present embodiment, if the external electrode is formed by dipping and blotting the ceramic body in the paste for forming the external electrode, the thickness of the external electrode becomes relatively thick, so the size of the portion contributing to the capacitance decreases, such that the performance of the multilayer ceramic capacitor may be deteriorated.

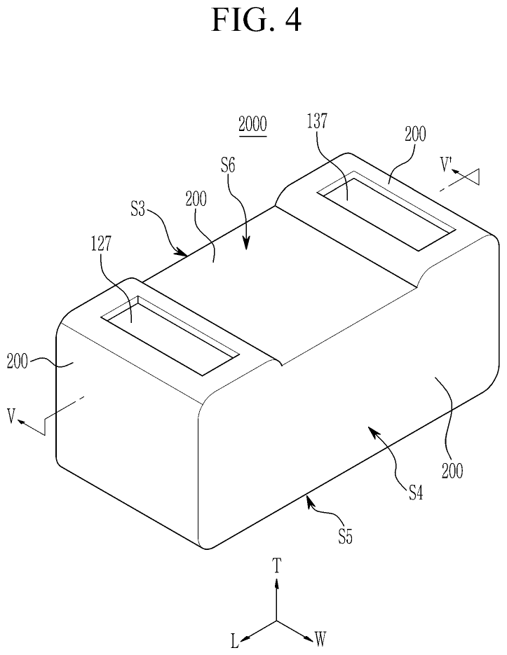

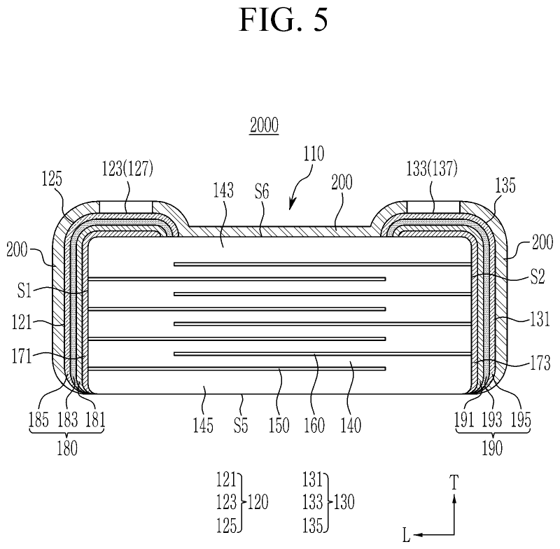

FIG. 4 is a perspective view schematically illustrating a multilayer ceramic capacitor according to another embodiment. FIG. 5 is a cross-sectional view taken along line V-V′ of FIG. 4.

Referring to FIG. 4 and FIG. 5, a multilayer ceramic capacitor 2000 includes the ceramic body 110, the first external electrode 120, the second external electrode 130, the plurality of first internal electrodes 150, the plurality of second internal electrodes 160, and an insulation layer 200. Except that the multilayer ceramic capacitor 2000 includes the insulation layer 200, remaining components are the same as or correspond to the components of the multilayer ceramic capacitor 1000 of FIG. 1, and thus redundant description thereof will be omitted.

The insulation layer 200 covers a portion of the first external electrode 120, a portion of the second external electrode 130 and a portion of the ceramic body 110.

The insulation layer 200 may include a thermoplastic resin such as polystyrene-based, acetic acid vinyl-based, polyester-based, polyethylene-based, polypropylene-based, polyamide-based, rubber-based, acryl-based, or the like, a thermosetting resin such as phenol-based, epoxy-based, urethane-based, melamine-based, alkyd-based, or the like, and a photosensitive resin, Parylene, SiOₓ or SiNₓ.

The insulation layer 200 may be formed by applying a liquid insulating resin to the surface of the ceramic body 110, by laminating an insulation film such as a dry film on the surface of the ceramic body 110, or through a thin film process such as atomic layer deposition (ALD) or vapor deposition. The insulation film may be Ajinomoto build-up film (ABF), polyimide film, or the like that does not include a photosensitive insulation resin.

The insulation layer 200 may entirely cover the first external electrode 120 on the first surface S1, the third surface S3, and the fourth surface S4 of the ceramic body 110, and may expose a portion of the first external electrode 120 on the sixth surface S6.

The insulation layer 200 may expose only a portion of an outer surface of the first external electrode 120 opposing the sixth surface S6 of the ceramic body 110, and may entirely cover a remaining portion of the first external electrode 120. In the first band portion 123 of the first external electrode 120, a portion of the first plated layer 180 may be exposed by the insulation layer 200 and comprise a first exposed surface 127. That is, the first exposed surface 127 may be a portion of an outer surface of the first plated layer 180 of the first external electrode 120. The first exposed surface 127 may be a rectangular shape of which four edges are surrounded by the insulation layer 200.

The first exposed surface 127 may be formed, for example, in the following way. A photoresist pattern that corresponds to the shape of the first exposed surface 127 is formed on the first external electrode 120. Next, the insulation layer 200 is deposited to entirely cover the first external electrode 120 and the photoresist pattern. Next, a portion of the insulation layer 200 and the photoresist pattern is removed such that the first exposed surface 127 is exposed. However, the present embodiment is not limited thereto.

In addition, the insulation layer 200 may entirely cover the second external electrode 130 on the second surface S2, the third surface S3, and the fourth surface S4 of the ceramic body 110, and may expose a portion of the second external electrode 130 on the sixth surface S6.

The insulation layer 200 may expose only a portion of an outer surface of the second external electrode 130 opposing the sixth surface S6 of the ceramic body 110, and may entirely cover a remaining portion of the second external electrode 130.

In the second band portion 133 of the second external electrode 130, a portion of the second plated layer 190 may be exposed by the insulation layer 200 and comprise a second exposed surface 137. That is, the second exposed surface 137 may be a portion of an outer surface of the second plated layer 190 of the second external electrode 130. The second exposed surface 137 may be a rectangular shape of which four edges are surrounded by the insulation layer 200.

The second exposed surface 137 may be formed, for example, in the following way. A photoresist pattern that corresponds to the shape of the second exposed surface 137 is formed on the second external electrode 130. Next, the insulation layer 200 is deposited to entirely cover the second external electrode 130 and photoresist pattern. Next, a portion of the insulation layer 200 and photoresist pattern is removed such that the second exposed surface 137 is exposed. However, the present embodiment is not limited thereto.

When mounting the multilayer ceramic capacitor 2000 on a substrate, the first exposed surface 127 of the first external electrode 120 and the second exposed surface 137 of the second external electrode 130 may be each connected to electrode pads of the substrate.

Meanwhile, the insulation layer 200 covers the sixth surface S6 of the ceramic body 110 between the first external electrode 120 and the second external electrode 130. That is, the insulation layer 200 may be disposed on the sixth surface S6 of the ceramic body 110 to cover a central portion of the sixth surface S6, and extend in the length direction (L-axis direction) to both sides to cover a portion of the first external electrode 120 and a portion of the second external electrode 130.

In addition, the insulation layer 200 may also be disposed on the third surface S3 and the fourth surface S4 of the ceramic body 110.

Meanwhile, insulation layer may not be disposed on the fifth surface S5 of the ceramic body 110.

As described above, the insulation layer 200 is disposed on at least a portion of the first surface S1, the second surface S2, the third surface S3, the fourth surface S4 and the sixth surface S6 of the ceramic body 110, such that an electrical short circuit between the external electrode of the multilayer ceramic capacitor and other electronic devices may be prevented.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A multilayer ceramic capacitor, comprising:
a ceramic body comprising a first surface and a second surface facing each other in a first direction, a third surface and a fourth surface facing each other in a second direction and connecting the first surface and the second surface, a fifth surface and a sixth surface facing each other in a third direction and connecting the first surface and the second surface;
a plurality of first internal electrodes and a plurality of second internal electrodes disposed inside the ceramic body;
a first external electrode disposed outside the ceramic body; and
a second external electrode disposed outside the ceramic body,
wherein the first external electrode includes (i) a first metal layer disposed on the first surface and the sixth surface of the ceramic body and electrically connected to the plurality of first internal electrodes on the first surface, and (ii) a first plated layer disposed on the first metal layer; and
wherein the second external electrode includes (i) a second metal layer disposed on the second surface and the sixth surface of the ceramic body and electrically connected to the plurality of second internal electrodes on the second surface, and (ii) a second plated layer disposed on the second metal layer.

2. The multilayer ceramic capacitor of claim 1, further comprising an insulation layer that covers a portion of the first external electrode on the sixth surface of the ceramic body and a portion of the second external electrode on the sixth surface of the ceramic body.

3. The multilayer ceramic capacitor of claim 2, wherein the insulation layer exposes a portion of an outer surface of the first external electrode opposing the sixth surface of the ceramic body and covers a remaining portion of the first external electrode, and exposes a portion of an outer surface of the second external electrode opposing the sixth surface of the ceramic body and covers a remaining portion of the second external electrode.

4. The multilayer ceramic capacitor of claim 3, wherein the outer surface of the first external electrode that is exposed by the insulation layer has a rectangular shape including four edges surrounded by the insulation layer, as viewed in a cross-section of the multilayer ceramic capacitor.

5. The multilayer ceramic capacitor of claim 4, wherein the outer surface of the second external electrode that is exposed by the insulation layer has a rectangular shape including four edges surrounded by the insulation layer, as viewed in the cross-section of the multilayer ceramic capacitor.

6. The multilayer ceramic capacitor of claim 3, wherein the insulation layer covers the sixth surface of the ceramic body between the first external electrode and the second external electrode.

7. The multilayer ceramic capacitor of claim 2, wherein the insulation layer covers the first external electrode on the first surface of the ceramic body, and covers the second external electrode on the second surface of the ceramic body.

8. The multilayer ceramic capacitor of claim 1, wherein the first plated layer comprises:
a first layer that covers the first metal layer;
a second layer that covers the first layer; and
a third layer that covers the second layer.

9. The multilayer ceramic capacitor of claim 8, wherein:
the first layer includes nickel (Ni);
the second layer includes copper (Cu); and
the third layer includes tin (Sn).

10. The multilayer ceramic capacitor of claim 1, wherein the second plated layer comprises:
a first layer that covers the second metal layer;
second layer that covers the first layer; and
a third layer that covers the second layer.

11. The multilayer ceramic capacitor of claim 10, wherein:
the first layer includes nickel (Ni);
the second layer includes copper (Cu); and
the third layer includes tin (Sn).

12. The multilayer ceramic capacitor of claim 1, wherein each of the first metal layer and the second metal layer includes a nickel (Ni) layer, a layer including titanium (Ti), and a layer including copper (Cu), or a layer including titanium (Ti), and a layer including chromium (Cr).

13. The multilayer ceramic capacitor of claim 1, wherein each of the first plated layer and the second plated layer includes a layer including nickel (Ni), and a layer including tin (Sn), a first layer including tin (Sn), a layer including nickel (Ni), and a second layer including tin (Sn), or a layer including nickel (Ni), a layer including copper (Cu), and a layer including tin (Sn).

14. The multilayer ceramic capacitor of claim 1, wherein a thickness of the first internal electrode is 100 nm or more and 300 nm or less, and a thickness of the second internal electrode is 100 nm or more and 300 nm or less.

15. The multilayer ceramic capacitor of claim 1, wherein the first metal layer is disposed only on the first surface and the sixth surface of the ceramic body.

16. The multilayer ceramic capacitor of claim 15, further comprising an insulation layer that covers a portion of the first external electrode on the sixth surface of the ceramic body and a portion of the second external electrode on the sixth surface of the ceramic body.

17. The multilayer ceramic capacitor of claim 16, wherein the insulation layer exposes a portion of an outer surface of the first external electrode opposing the sixth surface of the ceramic body and covers a remaining portion of the first external electrode, and exposes a portion of an outer surface of the second external electrode opposing the sixth surface of the ceramic body and covers a remaining portion of the second external electrode.

18. The multilayer ceramic capacitor of claim 19, wherein the first plated layer is disposed only on the first surface and the sixth surface of the ceramic body.
